(19) United States
(12) Patent Application Publication
(10) Pub. No.: US 2026/0024530 A1
(43) Pub. Date: Jan. 22, 2026

(54) TRAINING DATA GENERATING DEVICE AND TRAINING DATA GENERATING METHOD

(71) Applicant: HTC Corporation, Taoyuan City (TW)

(72) Inventors: Tzu-Tsai WEI, Taoyuan City (TW); Sheng-Hung FAN, Taoyuan City (TW); Yu-Shao PENG, Taoyuan City (TW)

(21) Appl. No.: 19/275,998

(22) Filed: Jul. 22, 2025

Related U.S. Application Data
(60) Provisional application No. 63/674,259, filed on Jul. 22, 2024.

(51) Int. Cl. G10L 15/26; G06F 16/31; G10L 15/06

(52) U.S. Cl. CPC G10L 15/26; G06F 16/316; G10L 15/063

(57) ABSTRACT

A training data generating device and a training data generating method are provided. The device stores first single language code data, the first single language code data corresponding to a first language. The device generates a second single language code data corresponding to each of the first single language code data based on a second language and a whole sentence translation algorithm. The second single language code data corresponding to the second language. The device aligns text segments corresponding to the first single language code data and the second single language code data. The device generates code-mixing data based on at least one valid segment position corresponding to the text segments of each of the first single language code data.

### CROSS-REFERENCE TO RELATED APPLICATION

This application claims priority to U.S. Provisional Application Ser. No. 63/674,259, filed Jul. 22, 2024, which is herein incorporated by reference in its entirety.

### BACKGROUND

### Field of Invention

The present invention relates to a training data generating device and a training data generating device method. More particularly, the present invention relates to a training data generating device and a training data generating method capable of generating a large amount of code-mixing training data.

### Description of Related Art

The Speech-To-Text (STT) task is to convert a speech file of a user's speech into text after it is recognized by an algorithm. A common challenge in the STT task is code mixing. For example, when a bilingual or multilingual user speaks, the user mixes elements of multiple languages (such as grammar, words, etc.) to produce a sentence. Currently, neural networks are the mainstream solution for achieving speech-to-text conversion, and the performance of neural networks is closely related to their training data.

However, since the performance of neural networks is largely related to training data, the current speech-to-text pairing training data is large and complete, but most of it is in a single language context, and the amount of code mixing data is very scarce (for example: a large amount of source data such as radio, TV dramas, news, etc. will try to avoid using code mixing materials). Therefore, the neural network model trained based on a single language data set is naturally difficult to cope with the complex situation of code-mixing.

In addition, under the same language combination (e.g., a mixed Chinese and English context), the differences in accent and word usage in each region may be very obvious (e.g., a mixed Chinese and English data set for Singaporean accents, a mixed Chinese and English data set for Malaysian accents). Each data set has its own characteristics of recording the speech of people from different ethnic groups or regions. If the user is expected to be a specific ethnic group (e.g., a mixed Chinese and English audio file for Hongkong), there will be a dilemma between the suitability and quantity of training data. If these data are used directly for model training, the resulting model will have difficulty coping with the accent habits of specific ethnic groups, because the way these specific groups speak has never appeared in the training data, and it can be expected that the model using these training data will perform poorly. However, if this problem is taken into consideration and the data is screened, the amount of data will be drastically reduced, further exacerbating the problem of scarcity of text and voice data.

Furthermore, some datasets are very specific in their fields, such as datasets recorded by medical staff in hospitals, where the scenes are all medical-related. Using this data will make the model perform well in hospitals or clinics, but when used in other fields such as business, education, sports, and daily conversations, it is expected that its performance will be greatly degraded. This situation will result in a high proportion of these data being unusable when developing a system for use in a specific area, because for the model, the way these specific people speak has never appeared in the training data, and it can be expected that the model will perform poorly after using these data to train the model.

The above problems of lack of suitable large amounts of training data make it difficult and challenging to train speech-to-text models. Therefore, the prior art lacks a method that can generate a large amount of correct code-mixed training data and is suitable for training speech-to-text models.

Accordingly, there is an urgent need for a training data generating technology that can generate a large amount of code-mixing training data.

### SUMMARY

An objective of the present disclosure is to provide a training data generating device. The training data generating device comprises a storage, a transceiver interface, and a processor. The processor is electrically connected to the storage and the transceiver interface. The storage is configured to store a plurality of first single language code data, wherein the plurality of first single language code data correspond to a first language. The processor generates a second single language code data corresponding to each of the plurality of first single language code data based on a second language and a whole sentence translation algorithm, wherein the plurality of second single language code data correspond to the second language, and the second language is different from the first language. The processor aligns a plurality of text segments corresponding to the plurality of first single language code data and the plurality of second single language code data. The processor generates a plurality of code-mixing data based on at least one valid segment position corresponding to the text segments of each of the plurality of first single language code data.

Another objective of the present disclosure is to provide a training data generating method, which is adapted for use in an electronic device. The electronic device is configured to store a plurality of first single language code data, the plurality of first single language code data correspond to a first language. The training data generating method comprises the following steps: generating a second single language code data corresponding to each of the plurality of first single language code data based on a second language and a whole sentence translation algorithm, wherein the plurality of second single language code data correspond to the second language, and the second language is different from the first language; aligning a plurality of text segments corresponding to the plurality of first single language code data and the plurality of second single language code data; and generating a plurality of code-mixing data based on at least one valid segment position corresponding to the text segments of each of the plurality of first single language code data.

According to the above descriptions, the training data generating technology (at least including the device and the method) provided by the present disclosure can perform whole sentence translation operations and alignment operations on easily accessible single language code data, and select text segments that are suitable for language replacement. Then, based on the valid segment positions corresponding to the text segments, a large amount of code-mixing data corresponding to the single language code data is generated. Therefore, the training data generating technology provided by the present disclosure can correctly and efficiently generate code-mixing data based on the characteristics of various languages and with reference to the content of the context. In addition, the training data generating technology provided by the present disclosure can actively screen out fields that should not be replaced through a variety of different screening operations (for example: part-of-speech screening operations, semantic unit merging operations, word similarity screening operations) to improve the correctness of the generated code-mixing data. Since the training data generating technology provided by the present disclosure can generate a large amount of suitable code-mixing training data, it solves the problems of the prior art.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a training data generating device of the first embodiment;

FIG. 2 is a schematic view depicting a training data generating operation of the first embodiment;

FIG. 3 is a schematic view depicting a training data generating operation of some embodiments;

FIG. 4 is a schematic view depicting a training data generating operation of some embodiments;

FIG. 5 is a schematic view depicting a training data generating operation of some embodiments;

FIG. 6A is a schematic view depicting an operation example of some embodiments;

FIG. 6B is a schematic view depicting an operation example of some embodiments; and

FIG. 7 is a partial flowchart depicting a training data generating method of the second embodiment.

### DETAILED DESCRIPTION

In the following description, a training data generating device and a training data generating method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

First, the application scenario of the present disclosure is briefly described. The present disclosure can generate a large amount of code-mixing data (i.e., code-mixing data including at least a second language) that can be used to train a speech-to-text model through a plurality of single language code data in a single language and the screening operation provided by the present disclosure. For example, converting a Chinese sentence provided by a user into a mixed Chinese-English sentence.

Then, in subsequent applications, the user can complete the training of the speech-to-text model based on the training data generated by the present disclosure as basic training data (i.e., code-mixing data) to enhance recognition capability of the speech-to-text model for code-mixing input data.

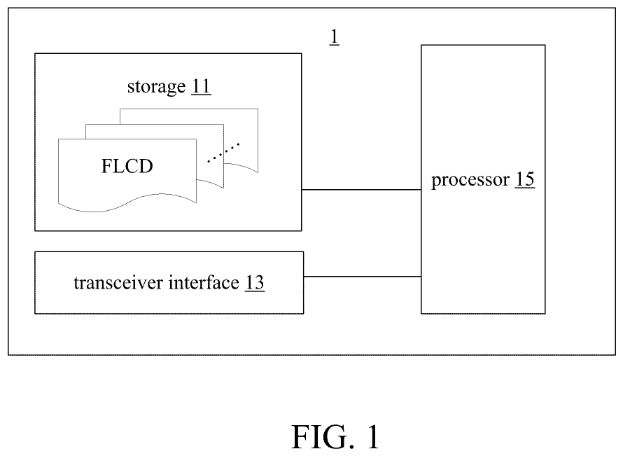

A first embodiment of the present disclosure is a training data generating device 1 and a schematic view of which is depicted in FIG. 1. In the present embodiment, the training data generating device 1 comprises a storage 11, a transceiver interface 13, and a processor 15, and the processor 15 is electrically connected to the storage 11 and the transceiver interface 13.

It shall be appreciated that the storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external devices, external web pages, external applications, and so on. The processor 15 may be any of various processors, Central Processing Units (CPUs), microprocessors, digital signal processors or other computing devices known to those of ordinary skill in the art.

In the present embodiment, as shown in FIG. 1, the storage 11 can be used to store a plurality of first single language code data, and the plurality of first single language code data correspond to a first language. For example, the first single language code data may be related data such as articles, sentences, common conversations, logical questions and answers, etc. collected from newspapers, media, magazines, etc., and described in Chinese.

Then, in the present embodiment, during translation, the whole sentence translation method will be used (that is, the context content in the single language code data can be simultaneously referred to) to generate a correct whole sentence translation corresponding to the second language. Specifically, the processor 15 of the training data generating device 1 generates a second single language code data corresponding to each of the plurality of first single language code data based on a second language and a whole sentence translation algorithm, the plurality of second single language code data correspond to the second language, and the second language is different from the first language.

It shall be appreciated that in the general prior art, if only a portion of the sentences/words selected from the single language code data are translated into corresponding words, it is possible that the meaning of the translation does not match the context or deviates from the original sentence content. Therefore, in order to correctly translate the single language code data, the present disclosure does not only translate part of the sentence or part of the word. The object of translation of the present disclosure is the entire sentence of the input data, and the whole sentence translation operation can ensure the discovery and retention of these context information (for example: word properties and relationships such as part of speech, tense, meaning, structure, etc.).

In some embodiments, the training data generating device 1 can improve the whole sentence translation capability for a specific target by self-training a language translation model for a specific target domain. In some embodiments, the training data generating device 1 can also use an existing translation system (e.g., Google Translate, ChatGPT) as a tool for whole sentence translation.

Next, in the present embodiment, the training data generating device 1 performs a text alignment operation on the translated sentences and the single language code data to pair together the segments with the same meaning in the two sentences. Specifically, the processor 15 of the training data generating device 1 aligns the plurality of text segments corresponding to the plurality of first single language code data and the plurality of second single language code data.

In some embodiments, the text segments in the aligned first and second single language code data should be completely corresponding (i.e., the respective text segments can correspond to each other). Specifically, the plurality of first single language code data comprise a first target single language code data, the plurality of second single language code data comprise a second target single language code data corresponding to the first target single language code data, and the aligned text segments in the first target single language code data correspond to the plurality of text segments in the second target single language code data respectively.

It shall be appreciated that the text segments that cannot be aligned may cause semantic errors in the subsequent language replacement operation. Therefore, in some embodiments, the text segments that cannot be aligned in the alignment operation are regarded as non-valid segments in the subsequent operation (i.e., excluded from the valid segments), and the text segments of the non-valid segments will not be used for the second language replacement in the subsequent operation.

In some embodiments, in order to correctly perform the alignment operation, the processor 15 may first perform a segmentation operation on the first single language code data and the second single language code data, and then match the segments with the same meaning. Specifically, the processor 15 performs a word segmentation operation on each of the plurality of first single language code data to generate a plurality of segmented segments of each of the plurality of first single language code data. Then, the processor 15 aligns the plurality of text segments corresponding to the plurality of first single language code data and the plurality of second single language code data based on the plurality of segmented segments.

For example, the processor 15 may input the translated complete English sentence and the word segmentation result of the Chinese sentence into a BERT-based alignment model for operation, so that the model can find the alignment segment between each Chinese segment and the second single language code data (i.e., English translated data).

Finally, in the present embodiment, the processor 15 of the training data generating device 1 generates a plurality of code-mixing data based on at least one valid segment position corresponding to the text segments of each of the first single language code data.

In some embodiments, each of the code-mixing data comprises at least one first text segment corresponding to the first language and at least one second text segment corresponding to the second language.

For example, the original first single language code data includes 7 segments. After the screening and judgment operation performed by the processor 15 of the present disclosure, only 5 valid segments remain in the first single language code data. The processor 15 can select one or more valid segments from the 5 valid segments to perform a replacement operation of the text segment corresponding to the second language. Through multiple replacement operations of different combinations, a plurality of code-mixing data are generated.

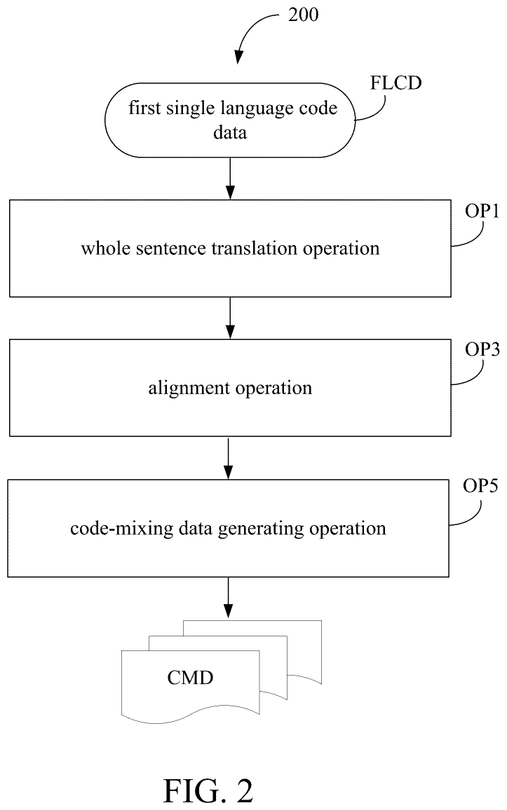

For ease of understanding, please refer to a code-mixing data generating operation diagram 200 shown in FIG. 2. In the present example, the processor 15 performs a whole sentence translation operation of operation OP1 on the first single language code data FLCD. Then, the processor 15 performs an alignment operation of operation OP3. Then, the processor 15 performs a code-mixing data generating operation of operation OP5 to generate the code-mixing data CMD.

In some embodiments, the processor 15 can further select valid segments by tagging the part of speech of each text segment. Specifically, the processor 15 performs a word segmentation operation on each of the plurality of first single language code data to generate a plurality of segmented segments of each of the plurality of first single language code data. Then, the processor 15 tags a part of speech of each of the plurality of segmented segments. Finally, the processor 15 generates the at least one valid segment position corresponding to the plurality of text segments of each of the plurality of first single language code data based on the part of speech of each of the segmented segments.

In some embodiments, the processor 15 can perform part-of-speech tagging through natural language processing technology. For example, according to different model designs, the tagging accuracy of the model is usually dozens of levels, including but not limited to place names (e.g., Britain), directional nouns (e.g., South), auxiliary words (e.g., of), etc.

In some embodiments, the processor 15 of the present disclosure may use Bi-GRU-CRF to segment words and tag parts of speech, so that the training data generating device 1 can clearly distinguish each member in the Chinese sentence structure.

In some embodiments, the processor 15 of the present disclosure may operate based on part-of-speech (POS) tagging and use POS-level word alignment and vector similarity to establish an inter-sentence code mixing dataset.

It shall be appreciated that the purpose of the word segmentation and the part-of-speech tagging disclosed in the present invention can achieve at least two effects. First, word segmentation can enhance the text alignment result produced during the text alignment operation. Second, the results of part-of-speech tagging can be used for the next step of part-of-speech screening.

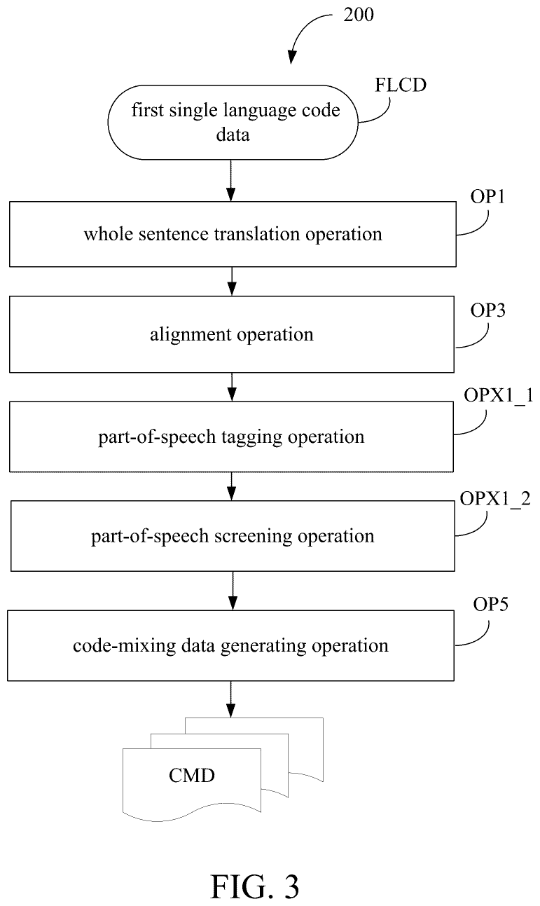

For ease of understanding, please refer to a code-mixing data generating operation diagram 200 shown in FIG. 3. In the present example, after executing the alignment operation of operation OP3, the processor 15 may execute the part-of-speech tagging operation OPX1_1 to generate the part-of-speech corresponding to each text segment. Then, the processor 15 executes the part-of-speech screening operation OPX1_2 to screen the part-of-speech that does not need/should not be translated, and update the valid segment position.

It shall be appreciated that the present disclosure does not limit the order in which the part-of-speech tagging operation OPX1_1 and the part-of-speech screening operation OPX1_2 are executed. For example, the part-of-speech tagging operation OPX1_1 can also be executed together with other operations, such as: executed after the word segmentation operation, and simultaneously with the whole sentence translation operation OP1.

In some embodiments, the processor 15 can further enhance the result of the alignment operation OP3 by using the parts of speech of the text segments generated by the part-of-speech tagging operation OPX1_1 (for example, by referring to the corresponding relationship of the parts of speech in the grammar).

In some embodiments, the processor 15 may aggregate each semantic unit with the alignment result to integrate multiple small semantic units to form a series of complete, larger semantic blocks. For example, if the Chinese represented text segments “ [symbol] ” and “ [symbol] ” are adjacent to each other (i.e., the text segments of the first single language code data), and both correspond to the English represented text segments “arrogant” (i.e., the text segments of the second single language code data), the processor 15 may merge the text segments “ [symbol] ” and “ [symbol] ” into “ [symbol] ”.

Specifically, the processor 15 compares any adjacent text segment in the text segments of each of the first single language code data with the text segments of each of the second single language code data to determine whether the adjacent text segment corresponds to the text segment with the same text content (i.e., a text segment expressed in another language). Finally, in response to determining that a first adjacent text segment corresponds to the same text content, the processor 15 merges the first adjacent text segment to update the text segments.

In some embodiments, the processor 15 may determine whether to merge text segments by comparing semantic vectors of adjacent text segments. Specifically, the processor 15 generates a semantic vector for each of the plurality of text segments. Then, the processor 15 compares the semantic vectors corresponding to any adjacent text segment in the text segments to determine whether the adjacent text segment is higher than a vector proximity value. Finally, in response to the semantic vectors corresponding to a first adjacent text segment being higher than the vector proximity value, the processor 15 merges the first adjacent text segment to update the plurality of text segments.

It shall be appreciated that the merging operation can prevent the processor 15 from over-splitting the words and sentences, so that the translation matching after this operation can be closer to the code mixing method used in reality. Therefore, after the semantic units are merged, the results generated by the algorithm disclosed in the present disclosure further have the advantage of semantic unit integrity.

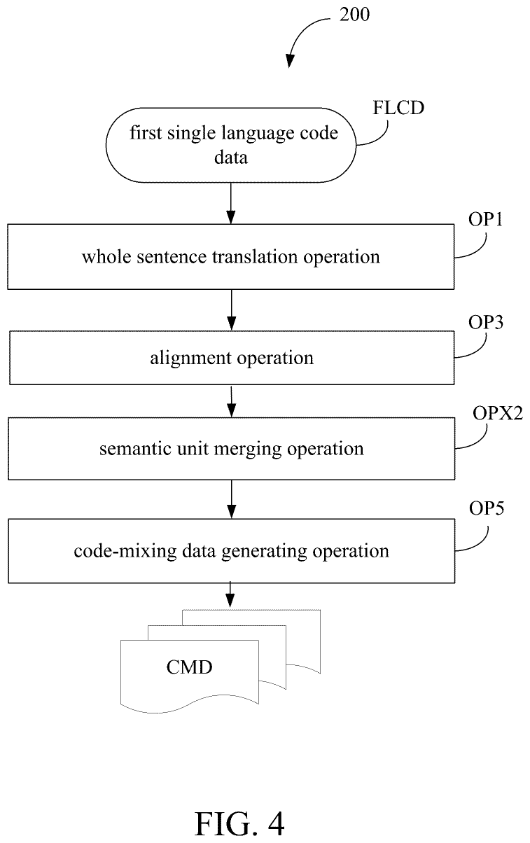

For ease of understanding, please refer to a code-mixing data generating operation diagram 200 shown in FIG. 4. In the present example, after executing the alignment operation of the operation OP3, the processor 15 may execute the semantic unit merging operation OPX2 to merge semantic blocks with similar meanings and update the text segments (i.e., the valid segments). Then, the processor 15 may execute the code-mixing data generating operation of the operation OP5 based on the updated text segments to generate the code-mixing data CMD.

In some embodiments, the processor 15 may further eliminate some of the translated segments that are not similar based on word similarity. Specifically, the processor 15 generates a first semantic vector for each of the plurality of text segments of the plurality of first single language code data, and generates a second semantic vector for each of the plurality of text segments of the plurality of second single language code data. Next, the processor 15 compares whether a similarity between the first semantic vector and the second semantic vector corresponding to any target text segment among the plurality of text segments is lower than a preset value. Finally, in response to the similarity between the first semantic vector and the second semantic vector corresponding to a first target text segment being lower than the preset value, the processor 15 removes the first target text segment to update the at least one valid segment position. In some embodiments, the processor 15 may convert the text segments into the same language and then compare the semantic vectors.

In addition, in response to the similarity between the first semantic vector and the second semantic vector corresponding to the first target text segment being higher than the preset value, the processor 15 retains the first target text segment to update the at least one valid segment position.

It shall be appreciated that the present disclosure checks the aligned Chinese-English pairing to ensure that the alignment result is correct. If the similarity between the two words in Chinese or English is greater than a certain threshold, it is determined that the Chinese word can be replaced with the English word it is aligned to, otherwise the pairing is filtered out. For example, the processor 15 may use a word to vector technology based on a neural network to project a single word into a multi-dimensional vector, and then compare the similarity between the two vectors to ensure that the Chinese word can be replaced by the aligned English word.

It shall be appreciated that the word similarity test can be carried out in a variety of different ways. For example, the processor 15 can translate the English word back into Chinese to test its similarity with the original text. In addition, the processor 15 can also translate the Chinese word back into English to test its similarity with the original text segment generated by the original full sentence translation.

For example, the first single language code data includes a text segment “ [symbol] ” expressed in Chinese. The processor 15 can translate the text segment “ [symbol] ” into English (i.e., the second language), and check the similarity between the translated content and the text segment “arrogant” expressed in English in the second single language code data (e.g., the semantic vector in the same language) to generate a first language similarity score.

In addition, the second single language code data includes a text segment “arrogant” expressed in English. The processor 15 can translate the text segment “arrogant” back into Chinese (i.e., the first language), and check the similarity between the translated content and the text segment “ [symbol] ” expressed in Chinese in the first single language code data to generate a second language similarity score. In this example, as long as any language similarity score exceeds the threshold, the processor 15 can determine that it is a reasonable situation and passes the test. Otherwise, the text segment is removed.

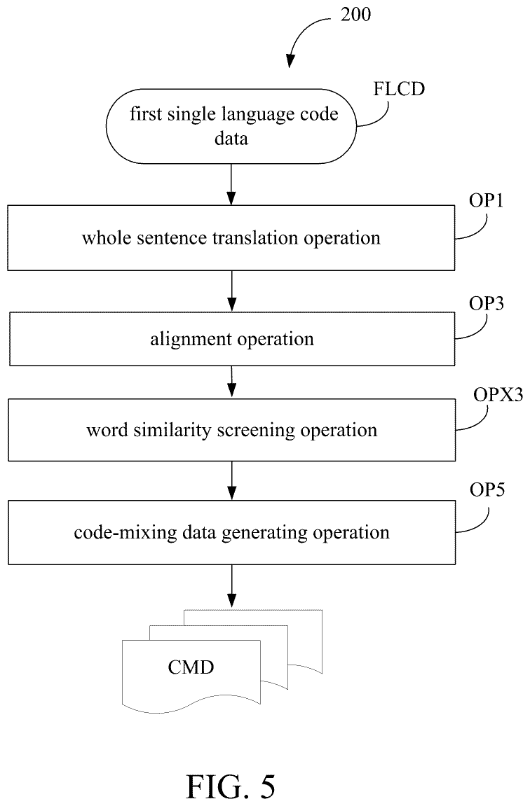

For ease of understanding, please refer to a code-mixing data generating operation diagram 200 shown in FIG. 5. In the present example, after executing the alignment operation of operation OP3, the processor 15 may execute the word similarity screening operation OPX3 to screen out text segments with dissimilar meanings and update the text segments (i.e., valid segments). Then, the processor 15 may execute the code-mixing data generating operation of operation OP5 based on the updated text segments to generate the code-mixing data CMD.

In some embodiments, the processor 15 can determine one or more replacement positions to be replaced from the at least one valid segment position, and perform a replacement operation based on the text segment of the second language corresponding to the replacement position. Specifically, a first target single language code data in the first single language code data corresponds to a second target single language code data in the second single language code data. First, the processor 15 determines a replacement segment position based on the at least one valid segment position corresponding to the text segments of the first target single language code data. Then, the processor 15 replaces the text segments of the first target single language code data to generate a first code-mixing data in the plurality of code-mixing data based on the second target single language code data and the replacement segment position.

In some embodiments, the processor 15 may further randomly generate one or more replacement positions based on a set number (for example, replacing at least 2 positions), and perform a replacement operation based on the text segment of the second language corresponding to the replacement position. Specifically, a first target single language code data in the first single language code data corresponds to a second target single language code data in the second single language code data. First, the processor 15 determines, based on the at least one valid segment position and a plurality of replacement quantity combinations corresponding to the text segments of the first target single language code data, at least one replacement segment position corresponding to each of the plurality of replacement quantity combinations. Next, the processor 15 randomly replaces the text segments of the first target single language code data to generate the plurality of code-mixing data based on the second target single language code data and the at least one replacement segment position of each of the replacement quantity combinations.

It shall be appreciated that, for other positions other than the valid segment position, the content in the original first single language code data FLCD is still used without replacement. For example, if there are 7 text segment positions, the valid segment positions are the 1st position, the 3rd position, the 4th position, and the 5th position. In the present example, the processor 15 can randomly/alternately replace the text segments in these valid segment positions with text segments represented in the second language (i.e., the text segments corresponding to the second target single language code data) by arrangement or combination, so as to generate multiple sets of different code-mixing data.

It shall be appreciated that the code-mixing ratio of Chinese and English in daily life will change according to the speaker's habits. The present disclosure simulates this characteristic and replaces a random number of words in Chinese sentences, so that the results produced are more diverse and natural while being of high quality.

In some embodiments, the processor 15 may generate text-speech pairing data based on the code-mixing data generated by the aforementioned operation to train a model. Specifically, the processor 15 inputs the plurality of code-mixing data into a text-to-speech system to generate a plurality of text-to-speech pairing data including the first language and the second language. Then, the processor 15 trains a speech-to-text model based on the plurality of text-to-speech pairing data.

In some embodiments, the present disclosure may employ existing text-to-speech (TTS) models. For example, the VITS (Variational Inference with adversarial learning for end-to-end Text-to-Speech) model architecture is a model that can speak the text input by the user.

In some embodiments, the present disclosure may first use pure Chinese and pure English text-to-speech pairing data to train the model, and then obtain a text-to-speech model that can speak Chinese and English. The Chinese speech may collect data of a certain regional accent (e.g., Malaysia) to make the model's accent close to that of Malaysians. In addition, when making the audio file, the present disclosure combines the generated Chinese and English code mixed text data set with the Malaysian accent audio data set used in training, and inputs them into the model to generate the audio file corresponding to each word. This step shows that this process can simulate the characteristics of the accent of a specific region based on the Chinese audio file data provided by the user.

It shall be appreciated that the subject and object of the first language and the second language referred to in the present disclosure can be interchangeable. For example, when the training is used to recognize a speech-to-text model with Chinese as the native speaker, the first language can be Chinese and the second language can be English. In addition, when the training is used to recognize a speech-to-text model with English as the native speaker, the first language can be English and the second language can be Chinese.

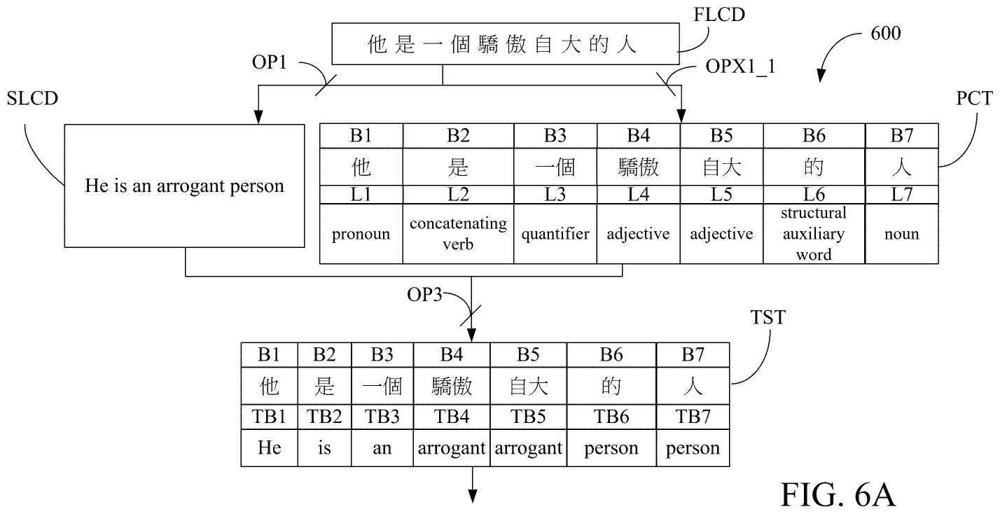

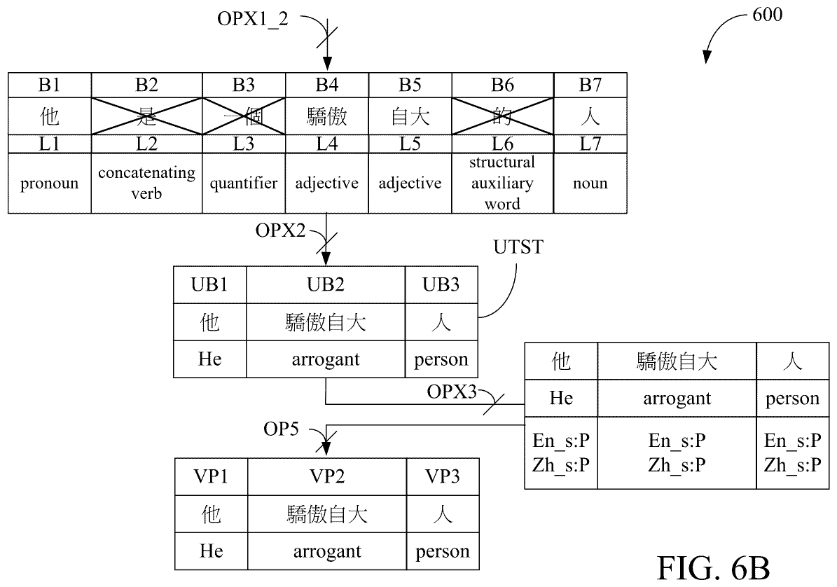

For ease of understanding, please refer to an operation example 600 of a code-mixing data generating operation shown in FIG. 6A and FIG. 6B. In the present example, a first single language code data FLCD (i.e., the data “ [symbol] [symbol] ” expressed in Chinese (“He is an arrogant person”)) is used as an example. In the present example, the first language is Chinese and the second language is English.

First, as shown in FIG. 6A, the processor 15 performs a whole sentence translation operation OP1 to translate the first single language code data FLCD into the second single language code data SLCD. In addition, the processor 15 performs a part-of-speech tagging operation OPX1_1 to generate a part-of-speech tagging correspondence table PCT.

In the present example, the part-of-speech tagging correspondence table PCT includes a plurality of text segments B1 to B7 and part-of-speech tags L1 to L7 corresponding to the text segments B1 to B7. The text segments B1 to B7 are “ [symbol] ”, “ [symbol] ”, “ [symbol] ”, “ [symbol] ”, “ [symbol] ”, “ [symbol] ”, “ [symbol] ”. The part-of-speech tags L1 to L7 are “pronoun”, “concatenating verb”, “quantifier”, “adjective”, “adjective”, “structural auxiliary word”, “noun”, respectively.

Next, the processor 15 performs an alignment operation OP3 to generate a text segment table TST. In the present example, the text segment table TST includes a plurality of text segments B1 to B7 and translation text segments TB1 to TB7 corresponding to the text segments B1 to B7. The translation text segments TB1 to TB7 are respectively “He”, “is”, “an”, “arrogant”, “arrogant”, “person”, “person”.

Next, please continue to refer to FIG. 6B. In the present example, the processor 15 performs the part-of-speech screening operation OPX1_2 to screen out some of the text segments. In the present example, the processor 15 determines that the parts of speech “concatenating verb”, “quantifier”, and “structural auxiliary word” are not suitable for language replacement, and therefore exclude them from the valid segments (i.e., the replacement operation is not performed at this position). Therefore, in the present example, the current valid segment positions are text segments B1, B4, B5, and B7.

Next, the processor 15 executes the semantic unit merging operation OPX2 to merge semantic blocks with similar meanings and generate an updated text segment table UTST. In the present example, the processor 15 determines that the adjacent text segments B4 and B5 have similar meanings, so the processor 15 merges the text segments B4 and B5 and generates new text segments UB1, UB2 and UB3.

Next, the processor 15 performs a word similarity screening operation OPX3 to screen out text segments with too low similarity. In the present example, the processor 15 determines that the words translated into Chinese or English for each text segment are similar (i.e., the English similarity En_s and the Chinese similarity Zh_s are both higher than the preset value, so it is determined to be passed), and there is no text segment that needs to be screened out.

Next, the processor 15 executes the code-mixing data generating operation OP5 to randomly generate code-mixing data based on the valid segment positions VP1, VP2, and VP3. For example, data such as “ [symbol] arrogant [symbol] ”, “He [symbol] arrogant [symbol] ”, “He [symbol] arrogant [symbol] person”, “He [symbol] [symbol] arrogant [symbol] person”, etc.

It shall be appreciated that each operation disclosed herein can be added or the execution order can be adjusted according to the application situation. For example, the operation OPX1_1, the operation OPX1_2, the operation OPX2, and the operation OPX3 can be selected to execute part or all of the operations according to the application environment.

According to the above descriptions, the training data generating device 1 provided by the present disclosure can perform whole sentence translation operations and alignment operations on easily accessible single language code data, and select text segments that are suitable for language replacement. Then, based on the valid segment positions corresponding to the text segments, a large amount of code-mixing data corresponding to the single language code data is generated. Therefore, the training data generating device 1 provided by the present disclosure can correctly and efficiently generate code-mixing data based on the characteristics of various languages and with reference to the content of the context. In addition, the training data generating device 1 provided by the present disclosure can actively screen out fields that should not be replaced through a variety of different screening operations (for example: part-of-speech screening operations, semantic unit merging operations, word similarity screening operations) to improve the correctness of the generated code-mixing data. Since the training data generating device 1 provided by the present disclosure can generate a large amount of suitable code-mixing training data, it solves the problems of the prior art.

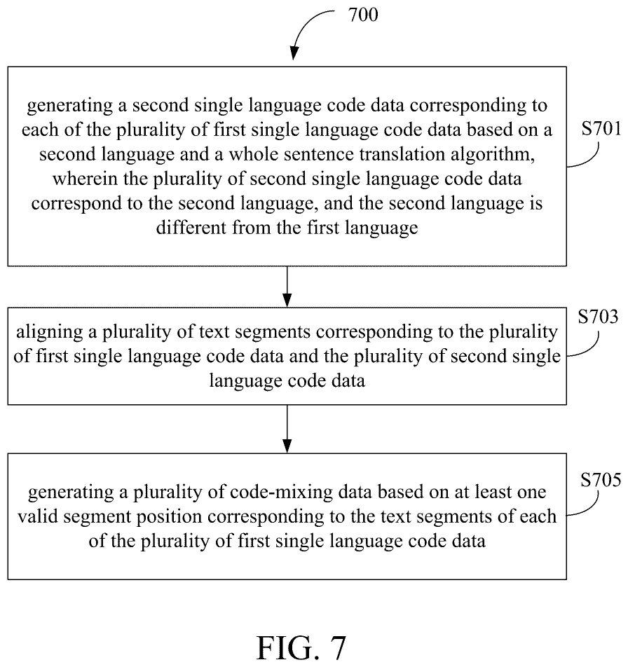

A second embodiment of the present invention is a training data generating method and a flowchart thereof is depicted in FIG. 7. The training data generating method 700 is adapted for use in an electronic device (e.g., the training data generating device 1 of the first embodiment). The electronic device comprises a storage, a transceiver interface, and a processor. The electronic device is configured to store a plurality of first single language code data, the plurality of first single language code data correspond to a first language. The training data generating method 700 generates a plurality of code-mixing data through the steps S701 to S705.

First, in the step S701, the electronic device generates a second single language code data corresponding to each of the plurality of first single language code data based on a second language and a whole sentence translation algorithm, wherein the plurality of second single language code data correspond to the second language, and the second language is different from the first language.

Next, in the step S703, the electronic device aligns a plurality of text segments corresponding to the plurality of first single language code data and the plurality of second single language code data.

Next, in the step S705, the electronic device generates a plurality of code-mixing data based on at least one valid segment position corresponding to the text segments of each of the plurality of first single language code data.

In some embodiments, wherein each of the code-mixing data comprises at least one first text segment corresponding to the first language and at least one second text segment corresponding to the second language.

In some embodiments, the step of aligning the plurality of text segments corresponding to the plurality of first single language code data and the plurality of second single language code data comprises the following steps: performing a word segmentation operation on each of the plurality of first single language code data to generate a plurality of segmented segments of each of the plurality of first single language code data; and aligning the plurality of text segments corresponding to the plurality of first single language code data and the plurality of second single language code data based on the plurality of segmented segments.

In some embodiments, the plurality of first single language code data comprise a first target single language code data, the plurality of second single language code data comprise a second target single language code data corresponding to the first target single language code data, and the aligned text segments in the first target single language code data correspond to the plurality of text segments in the second target single language code data respectively.

In some embodiments, the training data generating method 700 further comprises the following steps: performing a word segmentation operation on each of the plurality of first single language code data to generate a plurality of segmented segments of each of the plurality of first single language code data; tagging a part of speech of each of the plurality of segmented segments; and generating at least one valid segment position corresponding to the plurality of text segments of each of the plurality of first single language code data based on the part of speech of each of the segmented segments.

In some embodiments, the training data generating method 700 further comprises the following steps: comparing any adjacent text segment in the text segments of each of the first single language code data with the text segments of each of the second single language code data to determine whether the adjacent text segment corresponds to the text segment with the same text content; and in response to determining that a first adjacent text segment corresponds to the same text content, merging the first adjacent text segment to update the plurality of text segments.

In some embodiments, the training data generating method 700 further comprises the following steps: generating a first semantic vector for each of the plurality of text segments of the plurality of first single language code data; generating a second semantic vector for each of the plurality of text segments of the plurality of second single language code data; comparing whether a similarity between the first semantic vector and the second semantic vector corresponding to any target text segment among the plurality of text segments is lower than a preset value; and in response to the similarity between the first semantic vector and the second semantic vector corresponding to a first target text segment being lower than the preset value, removing the first target text segment to update the at least one valid segment position.

In some embodiments, a first target single language code data in the first single language code data corresponds to a second target single language code data in the second single language code data, and the operation of generating the plurality of code-mixing data comprises the following steps: determining a replacement segment position based on the at least one valid segment position corresponding to the text segments of the first target single language code data; and replacing the text segments of the first target single language code data to generate a first code-mixing data in the plurality of code-mixing data based on the second target single language code data and the replacement segment position.

In some embodiments, a first target single language code data in the first single language code data corresponds to a second target single language code data in the second single language code data, and the step of generating of the plurality of code-mixing data comprises the following steps: determining, based on the at least one valid segment position and a plurality of replacement quantity combinations corresponding to the text segments of the first target single language code data, at least one replacement segment position corresponding to each of the plurality of replacement quantity combinations; and randomly replacing the text segments of the first target single language code data to generate the plurality of code-mixing data based on the second target single language code data and the at least one replacement segment position of each of the replacement quantity combinations.

In some embodiments, the training data generating method 700 further comprises the following steps: inputting the plurality of code-mixing data into a text-to-speech system to generate a plurality of text-to-speech pairing data including the first language and the second language; and training a speech-to-text model based on the plurality of text-to-speech pairing data.

In addition to the aforesaid steps, the second embodiment can also execute all the operations and steps of the training data generating device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., the single language code data, the strong data augmentation image, the language, the text segment, the adjacent text segment, the semantic vector, the target text segment, the target single language code data, and the code-mixing data) are preceded by terms such as “first” or “second”, and these terms of “first” and “second” are only used to distinguish these different words. For example, the “first” and “second” in the first single language code data and the second single language code data are only used to indicate the different single language code data.

According to the above descriptions, the training data generating technology (at least including the device and the method) provided by the present disclosure can perform whole sentence translation operations and alignment operations on easily accessible single language code data, and select text segments that are suitable for language replacement. Then, based on the valid segment positions corresponding to the text segments, a large amount of code-mixing data corresponding to the single language code data is generated. Therefore, the training data generating technology provided by the present disclosure can correctly and efficiently generate code-mixing data based on the characteristics of various languages and with reference to the content of the context. In addition, the training data generating technology provided by the present disclosure can actively screen out fields that should not be replaced through a variety of different screening operations (for example: part-of-speech screening operations, semantic unit merging operations, word similarity screening operations) to improve the correctness of the generated code-mixing data. Since the training data generating technology provided by the present disclosure can generate a large amount of suitable code-mixing training data, it solves the problems of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A training data generating device, comprising:
a storage, being configured to store a plurality of first single language code data, wherein the plurality of first single language code data correspond to a first language;
a transceiver interface; and
a processor, being electrically connected to the storage and the transceiver interface, and being configured to perform operations comprising:
generating a second single language code data corresponding to each of the plurality of first single language code data based on a second language and a whole sentence translation algorithm, wherein the plurality of second single language code data correspond to the second language, and the second language is different from the first language;
aligning a plurality of text segments corresponding to the plurality of first single language code data and the plurality of second single language code data; and
generating a plurality of code-mixing data based on at least one valid segment position corresponding to the text segments of each of the plurality of first single language code data.

2. The training data generating device of claim 1, wherein each of the code-mixing data comprises at least one first text segment corresponding to the first language and at least one second text segment corresponding to the second language.

3. The training data generating device of claim 1, wherein the operation of aligning the plurality of text segments corresponding to the plurality of first single language code data and the plurality of second single language code data comprises the following operations:
performing a word segmentation operation on each of the plurality of first single language code data to generate a plurality of segmented segments of each of the plurality of first single language code data; and
aligning the plurality of text segments corresponding to the plurality of first single language code data and the plurality of second single language code data based on the plurality of segmented segments.

4. The training data generating device of claim 3, wherein the plurality of first single language code data comprise a first target single language code data, the plurality of second single language code data comprise a second target single language code data corresponding to the first target single language code data, and the aligned text segments in the first target single language code data correspond to the plurality of text segments in the second target single language code data respectively.

5. The training data generating device of claim 1, wherein the processor further performs the following operations:
performing a word segmentation operation on each of the plurality of first single language code data to generate a plurality of segmented segments of each of the plurality of first single language code data;
tagging a part of speech of each of the plurality of segmented segments; and
generating the at least one valid segment position corresponding to the plurality of text segments of each of the plurality of first single language code data based on the part of speech of each of the segmented segments.

6. The training data generating device of claim 1, wherein the processor further performs the following operations:
comparing any adjacent text segment in the text segments of each of the first single language code data with the text segments of each of the second single language code data to determine whether the adjacent text segment corresponds to the text segment with the same text content; and
in response to determining that a first adjacent text segment corresponds to the same text content, merging the first adjacent text segment to update the plurality of text segments.

7. The training data generating device of claim 1, wherein the processor further performs the following operations:
generating a first semantic vector for each of the plurality of text segments of the plurality of first single language code data;
generating a second semantic vector for each of the plurality of text segments of the plurality of second single language code data;
comparing whether a similarity between the first semantic vector and the second semantic vector corresponding to any target text segment among the plurality of text segments is lower than a preset value; and
in response to the similarity between the first semantic vector and the second semantic vector corresponding to a first target text segment being lower than the preset value, removing the first target text segment to update the at least one valid segment position.

8. The training data generating device of claim 1, wherein a first target single language code data in the first single language code data corresponds to a second target single language code data in the second single language code data, and the operation of generating the plurality of code-mixing data comprises the following operations:
determining a replacement segment position based on the at least one valid segment position corresponding to the text segments of the first target single language code data; and
replacing the text segments of the first target single language code data to generate a first code-mixing data in the plurality of code-mixing data based on the second target single language code data and the replacement segment position.

9. The training data generating device of claim 1, wherein a first target single language code data in the first single language code data corresponds to a second target single language code data in the second single language code data, and the operation of generating of the plurality of code-mixing data comprises the following operations:
determining, based on the at least one valid segment position and a plurality of replacement quantity combinations corresponding to the text segments of the first target single language code data, at least one replacement segment position corresponding to each of the plurality of replacement quantity combinations; and
randomly replacing the text segments of the first target single language code data to generate the plurality of code-mixing data based on the second target single language code data and the at least one replacement segment position of each of the replacement quantity combinations.

10. The training data generating device of claim 1, wherein the processor further performs the following operations:
inputting the plurality of code-mixing data into a text-to-speech system to generate a plurality of text-to-speech pairing data including the first language and the second language; and
training a speech-to-text model based on the plurality of text-to-speech pairing data.

11. A training data generating method, being adapted for use in an electronic device, wherein the electronic device is configured to store a plurality of first single language code data, the plurality of first single language code data correspond to a first language, and the training data generating method comprises the following steps:
generating a second single language code data corresponding to each of the plurality of first single language code data based on a second language and a whole sentence translation algorithm, wherein the plurality of second single language code data correspond to the second language, and the second language is different from the first language;
aligning a plurality of text segments corresponding to the plurality of first single language code data and the plurality of second single language code data; and
generating a plurality of code-mixing data based on at least one valid segment position corresponding to the text segments of each of the plurality of first single language code data.

12. The training data generating method of claim 11, wherein each of the code-mixing data comprises at least one first text segment corresponding to the first language and at least one second text segment corresponding to the second language.

13. The training data generating method of claim 11, wherein the step of aligning the plurality of text segments corresponding to the plurality of first single language code data and the plurality of second single language code data comprises the following steps:
performing a word segmentation operation on each of the plurality of first single language code data to generate a plurality of segmented segments of each of the plurality of first single language code data; and
aligning the plurality of text segments corresponding to the plurality of first single language code data and the plurality of second single language code data based on the plurality of segmented segments.

14. The training data generating method of claim 13, wherein the plurality of first single language code data comprise a first target single language code data, the plurality of second single language code data comprise a second target single language code data corresponding to the first target single language code data, and the aligned text segments in the first target single language code data correspond to the plurality of text segments in the second target single language code data respectively.

15. The training data generating method of claim 11, wherein the training data generating method further comprises the following steps:
performing a word segmentation operation on each of the plurality of first single language code data to generate a plurality of segmented segments of each of the plurality of first single language code data;
tagging a part of speech of each of the plurality of segmented segments; and
generating the at least one valid segment position corresponding to the plurality of text segments of each of the plurality of first single language code data based on the part of speech of each of the segmented segments.

16. The training data generating method of claim 11, wherein the training data generating method further comprises the following steps:
comparing any adjacent text segment in the text segments of each of the first single language code data with the text segments of each of the second single language code data to determine whether the adjacent text segment corresponds to the text segment with the same text content; and
in response to determining that a first adjacent text segment corresponds to the same text content, merging the first adjacent text segment to update the plurality of text segments.

17. The training data generating method of claim 11, wherein the training data generating method further comprises the following steps:
generating a first semantic vector for each of the plurality of text segments of the plurality of first single language code data;
generating a second semantic vector for each of the plurality of text segments of the plurality of second single language code data;
comparing whether a similarity between the first semantic vector and the second semantic vector corresponding to any target text segment among the plurality of text segments is lower than a preset value; and
in response to the similarity between the first semantic vector and the second semantic vector corresponding to a first target text segment being lower than the preset value, removing the first target text segment to update the at least one valid segment position.

18. The training data generating method of claim 11, wherein a first target single language code data in the first single language code data corresponds to a second target single language code data in the second single language code data, and the step of generating the plurality of code-mixing data comprises the following steps:
determining a replacement segment position based on the at least one valid segment position corresponding to the text segments of the first target single language code data; and
replacing the text segments of the first target single language code data to generate a first code-mixing data in the plurality of code-mixing data based on the second target single language code data and the replacement segment position.

19. The training data generating method of claim 11, wherein a first target single language code data in the first single language code data corresponds to a second target single language code data in the second single language code data, and the step of generating of the plurality of code-mixing data comprises the following steps:
determining, based on the at least one valid segment position and a plurality of replacement quantity combinations corresponding to the text segments of the first target single language code data, at least one replacement segment position corresponding to each of the plurality of replacement quantity combinations; and
randomly replacing the text segments of the first target single language code data to generate the plurality of code-mixing data based on the second target single language code data and the at least one replacement segment position of each of the replacement quantity combinations.

20. The training data generating method of claim 11, wherein the training data generating method further comprises the following steps:
inputting the plurality of code-mixing data into a text-to-speech system to generate a plurality of text-to-speech pairing data including the first language and the second language; and
training a speech-to-text model based on the plurality of text-to-speech pairing data.
